(19) United States
(12) Patent Application Publication
(10) Pub. No.: US 2010/0132747 A1
(43) Pub. Date: Jun. 3, 2010

(54) Thermal De-Scaling Surfaces With Cryogenic Liquids And Gases

(76) Inventors: Ken Smith, Galveston, TX (US); H. Wayne Hayden, Knoxville, TN (US); Jeff Bentley, Corpus Christi, TX (US)

Correspondence Address: LAW OFFICE OF DAVID MCEWING, P.O. BOX 231324, HOUSTON, TX, 77023, US

(21) Appl. No.: 12/325,649

(22) Filed: Dec. 1, 2008

(51) Int. Cl. B08B 3/02

(52) U.S. Cl. 134/31; 134/105

(57) ABSTRACT

Cryogenic fluids are used to remove contaminants such as hard scale deposits from heating and/or heat transfer equipment. The fluid may be cryogenically cooled to achieve a liquid phase and/or a mixture of liquid and gas phases. The fluid may also be pressurized. The mixture does not include a solid phase. A particle injection port is not required. The cryogenic fluid contacting the surface of a scale or other contaminant that has built-up during service of heating or heat exchanging equipment causes a near instantaneous contraction at the scale surface. Cracks form at the scale surface contacted by the cryogenic fluid. These cracks extend through the scale thickness to the underlying material of the equipment of the heating and/or heat exchanging component. The fractured surface scale separates by spalling or de-cohesion from the underlying equipment structure and is moved off the surface by the action of the exiting cryogenic fluid.

### BACKGROUND OF INVENTION

1. Field of Use

The invention taught by this specification has multiple uses, including but not limited to de-scaling of heating and heat exchanging equipment components, hard rock drilling, surface and underground mining components. These components include pipes, channels, tubes, shells, and surfaces.

2. Related Technology

Cryogenic liquids have been used in conjunction with solids to cut and abrade, i.e., wear down by use of friction, the scale that has become built-up on metal surfaces such as tubes. Existing technology uses pumps, heat exchangers, nozzles, etc., to create a tri-state stream composed of liquid, solid, and vapor phases of the cryogenic liquids. This tri-state mixture can be dispersed at high velocity and pressure onto hard scale deposits that have formed on the surface of equipment such as of heating or heat exchanging components. The scale deposits are cut or abraded by the solid phase particles, e.g., frozen CO₂, N₂, etc., from the metal surface. This method can also lead to harmful cutting or abrading of the underlying material(s), e.g., tubes, comprising the heating or heat exchanging components.

Multiple liquids or gases may be used. For example, cryogenically cooled liquid nitrogen may be use with liquid carbon dioxide. The carbon dioxide will freeze upon contact with the cooled nitrogen, thereby forming a solid for abrading deposits.

The liquid and vapor phase fluids are used to control and direct the solid phase in relation to the surface to be abraded. The solid particles can travel at several times the speed of sound, i.e., 2300 mph, or greater. The liquid phase can be at a pressure between 30,000 psig and 70,000 psig.

Liquids alone have also been used in numerous cases to cut and abrade objects in applications ranging from industrial equipment cleaning to high speed dental drilling.

### SUMMARY OF INVENTION

The disclosure of this specification includes a faster and more efficient method of removing scale deposits from tubes, pipes and channels utilizing cryogenic fluids containing liquid, gas, or a combination of liquid and gas phases. In order to obtain cryogenic liquids, gases must be cooled to very low temperatures, and, in certain cases such as carbon dioxide, pressurized to achieve a liquid phase. In order to develop supersonic speeds as the cryogenic fluids exit the nozzles, the liquid or liquid and gas mixture will be pressurized. The mixtures of the present invention do not include direct injection of any solid phases to the nozzle assembly. Therefore there is no risk of solid particles clogging the flow of cryogenic liquids and gases. Solid phases may form after the cryogenic fluid exits the nozzle. The absence of solid particles in the feed to the nozzle simplifies the design and operation of the nozzle. A mixing chamber or particle injection port is not required.

The cryogenic fluid contacting a surface coated with scale or other contaminants (hereinafter “scale” or “scale deposits”) that originally was at ambient temperature causes instantaneous cooling of the contacted surface of the scale leading to a near instantaneous thermal induced contraction of the contacted surface of the scale. The cryogenic fluid may be at a temperatures as low as −150° C. There exists an abrupt temperature difference between the cryogenic fluid and the scaled surface existing at ambient temperature. Because of the low thermal conductivity of the scale deposit, the contacted surfaces of the scale are constrained from fully contracting. This leads to the development of tensile stresses at the scale surfaces and the formation of brittle cracks at the surface of the scale deposits contacted by the cryogenic fluid. These cracks then proceed to extend through the scale thickness to the underlying component structure. The fractured scale deposit separates from the underlying structure and is moved off the surface by the high velocity action of the liquid or gas phases of the cryogenic fluid.

### SUMMARY OF DRAWINGS

The accompanying drawings, which are incorporated in and constitute a part of the specification, illustrate preferred embodiments of the invention. These drawings, together with the general description of the invention given above and the detailed description of the preferred embodiments given below, serve to explain the principles of the invention.

FIGS. 1A through 1D illustrate the manner in which scale deposits are removed from heating or heat exchanging equipment following the teachings of this invention.

FIG. 1A shows a cross sectional view of heater piping containing scale deposits being contacted by a flow of cryogenic fluid

FIG. 1B is a cross sectional blown-up view of a section of the piping of 1A that shows the initiation of brittle cracks at the surface of the scale deposit resulting from the combination of thermal shock by being contacted by the cryogenic fluid, and tensile stresses developed from mechanical constraint of the underlying scale material.

FIG. 1C is a blown-up drawing of the piping illustrated in FIG. 1B that shows the propagation of brittle cracks through the scale deposit from the surface contacted by the cryogenic fluid toward the interface between the scale and the pipe.

FIG. 1D is a blown-up drawing of the piping of FIGS. 1B and 1C that shows the separation of the scale from the pipe by spalling and de-cohesion.

### DETAILED DESCRIPTION OF INVENTION

Cleaning and maintenance of industrial equipment containing scale is a significant problem. Cleaning and maintenance requires the equipment to be taken out of service, thereby resulting in lost production. A system or method that can perform this cleaning in shorter time has obvious utility.

Scale can be the build up of mineral deposits from water or other sources. Other sources of scale within the chemical, petrochemical and mineral processing industries and which may be removed by this invention include unwanted byproducts of chemical reactions occurring in the process.

The cleaning and maintenance function can also be a dangerous undertaking for employees or contractors. For example, some methods and tooling for the cutting or abrading of surface scale deposits requires the operator to handle drilling equipment with high-speed water flows which frequently leads to cutting and abrading of the component materials of the equipment. Other methods involve the use of strong acids that dissolve the scale deposits and, frequently lead to corrosion of underlying component materials of the equipment. Other methods involve the use of nozzles spraying streams of cryogenically cooled liquid, solid particles, and gas. In one example, the nozzle emits the tri-state mixture as a high velocity jet cooled to −240° F. (151° C.) at 60,000 to 70,000 psig. The particle stream may have a velocity in excess of 3,000 feet per second or 2,300 mph.

This disclosure teaches a process for removing hard scale deposits from heating, cooling, and heat transfer equipment as used by the chemical, petrochemical, and mineral processing industries. The equipment may be constructed of metal or alloys of metal, as well as polymers, ceramics and composites. The process uses thermal shocking of the scale deposits built up on the surface of the equipment. Thermal shocking involves the cryogenic fluid, at temperatures as low as −150° C., (−238° F.) instantly contacting the scale deposit existing at ambient temperature. The abrupt, instantaneous temperature change causes the contacted outer layer of scale to contract and crack. Cracks propagate through the scale towards the underlying interface where the scale deposit is built-up on the surface of the component material of the equipment. Finally, the fractured scale deposits spall from the underlying surface, i.e., the scale deposits break up into chips and fragments. This scale deposit removal process is faster than the cut and abrade technology currently in use.

Hard scale deposits are also removed by de-cohesion. This effect is produced by the scale being contacted by the cryogenic fluid. This thermal shock causes the loss of adhesive properties between the equipment surface and the scale. Differing coefficients of thermal expansion of the deposit and the component material may contribute to the de-cohesion.

One embodiment of the invention teaches the use of cryogenic fluids delivered to the surfaces to be cleaned at high pressures and supersonic velocities. This facilitates an adequate mass flow of cryogenic fluid to contact the scale deposit. Deposits or layers of hard scale (hereinafter “scale deposits”) are removed and cleaned by the combination of step A through D.

A. Thermally shocking of the scale surfaces by rapid contraction of the cryogenically cooled scale surface. Due to the low thermal conductivity of the scale volume, surface contraction is constrained leading to the establishment of tensile stresses at the contacted scale surfaces.

B. The initiation of brittle cracking through the hard scale, from the contacted surfaces of the scale contacted with the cryogenic fluid that then extend through the scale thickness to the underlying surfaces of the containing metal surface of the equipment.

C. Release of fragments of the hard scale from the surfaces of the equipment by spalling or de-cohesion without cutting or abrading.

D. Removal of the scale fragments which become entrained in the gases produced when the cryogenic fluid fully volatilizes.

The method taught by this disclosure permits the removal of scale deposits more rapidly than achieved in drilling, acid cleaning, or cutting and abrading using cryogenic fluids. In a trial demonstration of the thermal shock method conducted at the Sherwin Alumina facility in Corpus Christi, Tex., it was demonstrated that scale deposits on one heat exchanger tube could be removed using thermal shocking as taught by this disclosure in one minute. In contrast, scale deposits of a similar heat exchanger tube could be removed in approximately 5 to 8 minutes including drilling and high speed water jets to cut, abrade and drill the tube.

A bench scale test was: also conducted wherein a 3 foot length of fully clogged heat exchanger tubing, supplied by the Sherwin Alumina facility in Corpus Christi, was de-scaled using the invention. The OD of the heat exchanger tubing was 1½ inches. Liquid carbon dioxide was used at a pressure of 22,000 psig and a flow rate in the rage of 5 to 7 gallons per minute. A handheld probe was utilized with a rotating nozzle. The clogged tube was unclogged and de-scaled in a period of less than 15 seconds. The scale product was removed as particulate solids and the surface of the tube after processing was free of all scale deposits.

Disposal of waste can also be facilitated by the size of the spalled pieces of scale deposit from the invention in contrast to the fine powdery reside of the prior art cutting and abrading technique.

In addition, because the present method does not involve the use of Water or water solutions, the scale solids removed by the present method will not require chemical treatment or drying prior to disposal.

The process and apparatus of the invention may utilize known technology and equipment (hereinafter “distribution components”) for cooling and pressurizing gas in a vapor phase to a cryogenically cooled and pressurized liquid. This may include a supply of gas such as Nitrogen, carbon dioxide, Oxygen or air. Use of Nitrogen, Oxygen or air will be more beneficial to the environment than use of carbon dioxide. It may be essential to utilize spark abatement techniques when liquid Oxygen and/or liquid air is utilized. Oxygen and Nitrogen have similar molecular weights, boiling points and melting points. Liquid air is essentially 80/20 mixture of Nitrogen and Oxygen after removal of water vapor and carbon dioxide. Use of liquid air or Oxygen will prevent the operator from being overcome with carbon dioxide or Nitrogen gas.

In one embodiment, the vaporous gas may be drawn from the storage tank through a strainer and valve assembly cooled to a temperature appropriate for liquification, and then transferred to a pump (hereinafter “pressure mechanism”). At this pressure mechanism, the vaporous gas may be compressed to a liquid phase. A portion may be drawn off and returned to a vapor phase where it may be injected through a nozzle. The remainder of the liquid phase gas may be further compressed and chilled utilizing one of more heat exchangers and intensifier pumps.

In another embodiment, only liquefied gas is delivered to and through the nozzle.

Depending on the particular gas or gas mixtures used for a given application, the pressure of the cryogenic liquid phase gas entering the nozzle may be in the range of 5,000 to 40,000 psig and the temperature may be in the range of −205° to −25° C. (−320° to −15° F.). It will be appreciated that there may be additional distribution components such as pumps and heat exchangers, piping and valves, nozzles and ancillary equipment known to persons skilled in the technology.

In one embodiment, the equipment may include one or more nozzles each comprised of two or more nozzle outlets oriented in separate directions. In one embodiment, two nozzle outlets have parallel axis of orientation but with each outlet directed in an opposite direction.

Each nozzle may rotate on an axis at speeds greater than 2100 miles per hour. The nozzle may also move forward and back on the nozzle axis of rotation. An example of this type of a nozzle is described in U.S. Pat. No. 5,706,842 issued to Raoul Caimi et al. and which is incorporated by reference herein.

The invention benefits from the liquid phase traveling from the nozzle at the stated speed in order to achieve an adequate liquid mass flow rate needed to create the thermal shock. Achieving this speed is facilitated by the pressure levels of the liquid phase entering the nozzle.

In another embodiment, the nozzle does not rotate and the velocity of the cryogenic fluid exiting the nozzle may be less than 2300 mph.

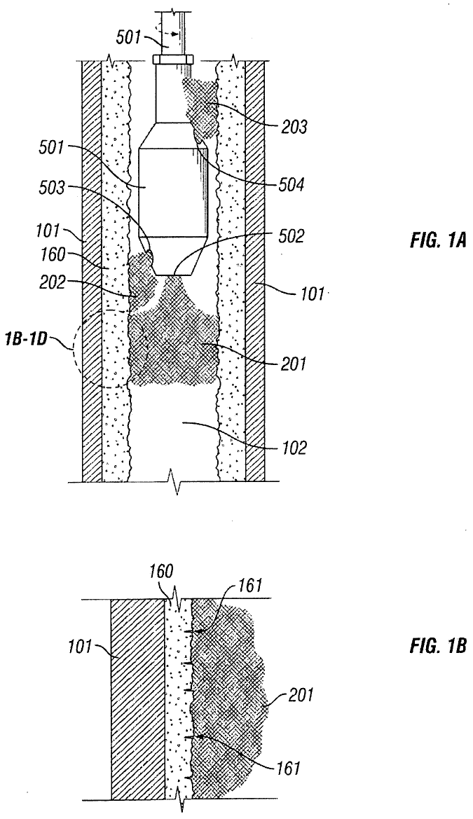

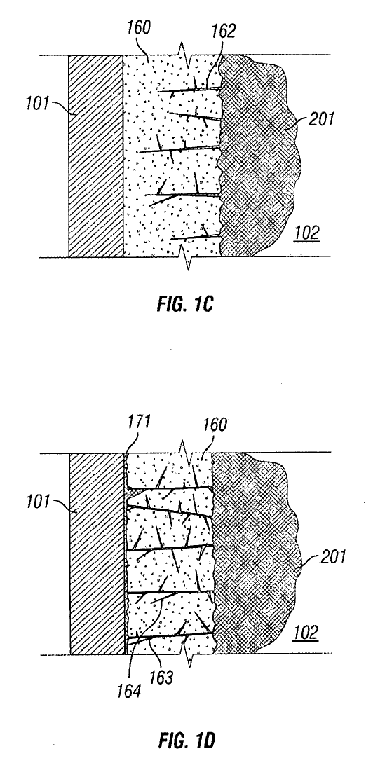

FIG. 1A illustrates a nozzle 501 comprised of 3 outlets 502, 503, 504. Also illustrated is a cross sectional view of a tube or pipe 101 containing a layer of scale deposit 160. The pipe contains an annulus 102 through which the nozzle passes. The nozzle disperses cryogenic fluid 201, 202, 203 which contacts the layer of scale deposit. Further illustrated is a detail of the pipe section subject of FIGS. 1B-1D.

FIG. 1B illustrates the initial formation of brittle cracks 161 from thermal shocking on the surface of the scale deposit 160 lining the pipe or tube 101 surface. The thermal shocking is the result of the scale deposit being exposed to the cryogenic fluid 201 dispersed from the nozzle (not shown) and the tensile stresses developed by the mechanical constraint of the underlying scale material. The low thermal conductivity of the scale deposit constrains the deposit from fully contracting from the rapid surface temperature drop.

FIG. 1C illustrates the further propagation of cracks 162 penetrating through the scale deposit layer 160. Also illustrated is the pipe 101 and pipe annulus 102 and the cryogenic fluid 201.

FIG. 1D illustrates the pipe 101 and pipe annulus. The cracks 163, 164 penetrate through the scale deposit layer 160. The fracturing of the scale deposit includes de-cohesion 171 of the scale from the pipe wall. Also illustrated is the cryogenic fluid 201.

This specification is to be construed as illustrative only and is for the purpose of teaching those skilled in the art the manner of carrying out the invention. It is to be understood that the forms of the invention herein shown and described are to be taken as the presently preferred embodiments. As already stated, various changes may be made in the shape, size and arrangement of components or adjustments made in the steps of the method without departing from the scope of this invention. For example, equivalent elements may be substituted for those illustrated and described herein and certain features of the invention maybe utilized independently of the use of other features, all as would be apparent to one skilled in the art after having the benefit of this description of the invention.

While specific embodiments have been illustrated and described, numerous modifications are possible without departing from the spirit of the invention, and the scope of protection is only limited by the scope of the accompanying claims.

What we claim is:

1. An apparatus for removing scale deposits from an equipment surface comprising:
a) a gas supply system;
b) one or more pressure mechanisms to pressurize the gas;
c) one or more cooling mechanisms to cool the gas to a cryogenic temperature at which the gas becomes a liquid; and
d) a nozzle to deliver the cryogenic liquid to an equipment surface to thermally shock scale deposited on the equipment.

2. The apparatus of claim 1 wherein the nozzle rotates sufficiently that the exiting liquid can achieve a velocity of 2,100 mph.

3. The apparatus of claim 2 wherein the nozzle moves transversely across the axis of rotation.

4. The apparatus of claim 1 wherein the nozzle further comprises two or more nozzle outlets wherein at least one is oriented in a separate direction.

5. The apparatus of claim 1 wherein the nozzle further comprises two or more nozzle outlets further comprising two nozzle outlets oriented on parallel axis but each directed in opposite directions.

6. A method for removing scale from an equipment surface comprising: contacting a scaled deposit on an equipment surface with cryogenic fluid cooled to −205° to −25° C. wherein a thermal difference exists of at least 50° C. between the equipment surface and cryogenic fluid and resulting in fracturing of the scale deposit.

7. The method of claim 6 further comprising removing the scale deposit through the volatilization of the cryogenic fluid.

8. The method of claim 6 further comprising removing the scale deposit with pressurized gas after contacting the scale deposit with the cryogenic liquid.

9. The method of claim 6 wherein the equipment surface is metal, alloy of metal, ceramic, polymer or composite.

10. The method of claim 6 further comprising removing the scale deposit at least 4 times faster than removal of scale deposits including use of drilling and high speed water jets to cut, abrade and drill the scale deposits from the equipment surface.

11. A method of removing scale from equipment surfaces comprising the steps of:
a) converting a gas in a vapor phase to a liquid phase by at least one step including lowering the temperature of the gas or raising the pressure of the gas sufficiently so that a cryogenic fluid forms;
b) distributing the cryogenic fluid to a nozzle;
a) discharging the cryogenic fluid from the nozzle onto scale deposits to thermally shock the scale deposits;
b) using the thermal shocking of the scaled deposits to rapidly contract the surfaces of the cryogenically cooled scale deposits;
c) creating tensile stresses within the contacted scale deposits;
d) initiating the formation and propagation of brittle cracks from the cryogenically cooled scale surface through the scale layer to the equipment surface; and
e) separating the scale from the equipment surfaces by spalling and de-cohesion.

12. The method of claim 11 wherein the equipment surface has a different coefficient of thermal expansion than the scale deposit.

13. The method of claim 11 wherein the liquid phase is discharged from the nozzle under pressure in the range of about 5,000 to 40,000 psig.

14. The method of claim 11 wherein the liquid phase is discharged from the nozzle at a velocity of about 2100 mph.

15. The method of claim 11 wherein the cryogenic fluid comprises Nitrogen.

16. The method of claim 11 wherein the cryogenic fluid comprises carbon dioxide.

17. The method of claim 11 wherein the cryogenic fluid comprises Oxygen.

18. The method of claim 11 wherein the cryogenic fluid comprises air.
